(19) United States
(12) Patent Application Publication
(10) Pub. No.: US 2017/0010583 A1
(43) Pub. Date: Jan. 12, 2017

(54) DATA ENCODING METHOD, COMPUTER READABLE RECORDING MEDIUM, AND DATA ENCODING DEVICE

(71) Applicant: Foundation of Soongsil University-Industry Cooperation, Seoul (KR)

(72) Inventors: Jaejin LEE, Seoul (KR); Seongkwon JEONG, Seoul (KR)

(21) Appl. No.: 14/858,562

(22) Filed: Sep. 18, 2015

(30) Foreign Application Priority Data
Jul. 6, 2015 (KR) 10-2015-0095897

(51) Int. Cl. G03H 1/02

(52) U.S. Cl. CPC G03H 1/02

(57) ABSTRACT

A data encoding method for 3n number of symbol data, n being a natural number is provided. The method includes mapping, according to a first mapping rule, 2n number of symbol data out of the 3n number of symbol data into a first group, converting, according to a second mapping rule, n number of symbol data out of the 3n number of symbol data into a second group, arranging the first group and the second group in each of the plurality of modulation units, each of the symbol data of the first group being not adjacent to one another, and each of the symbol data of the second group located between the adjacent symbol data of the first group, and outputting a modulation page having 2N×2M pixels, each of N and M being a natural number. Each of a plurality of modulation units includes the first group and the second group.

### CROSS-REFERENCE TO RELATED APPLICATION

This application claims priority to and the benefit of Korean Patent Application No. 10-2015-0095897, filed on Jul. 6, 2015, the disclosure of which is incorporated herein by reference in its entirety.

### BACKGROUND

The present disclosure relates to a data encoding method of multilevel symbol data, and a recording medium and device for performing the same, and more particularly, to a data encoding method of a multilevel symbol data capable of recording data by minimizing effects of peripheral noise when communicating or storing information and reducing a final bit error rate when playing data, and a recording medium and device for performing the same.

Since a holographic data storage (HDS) device performs recording and playback in units of pages, the total storage capacity of a storage medium is determined as a value obtained by multiplying the total number of bits that one page has and the number of multiplexed holograms. Since input data is recorded and read in units of two-dimensional pages in a volume of a hologram, the storage capacity is greatly increased.

Further, since it is possible to process a signal in units of two-dimensional pages, data transmission speed is also greatly increased. A factor which mainly makes errors is an inter-symbol interference (ISI) in a data storage device storing information in a surface like a conventional data storage device, and there is an inter-page interference (IPI) since the HDS device stores data while overwriting the data in the volume of the medium in units of pages.

Since the HDS device writes and reads data in units of pages, the ISI affects two-dimensionally. In the case of a binary pixel, a situation of generating the greatest ISI occurs when having isolated pixel patterns like a case in which a pixel of 0 (or 1) is surrounded by pixels of 1 (or 0). When the HDS device is multilevel and the highest level and the lowest level are adjacent, a symbol of the highest level gives a severe interference to a symbol of the lowest level.

As such, when the two-dimensional ISI occurs in a communication system or an information storage device in which two-dimensionally processes data like a HDS device channel, bit error rate (BER) performance is greatly reduced when detecting a signal.

In order to solve the problem, various methods have been proposed. Representatively, a code table is used in order to convert 3-bit input data into modulated 4-bit data in Korean Unexamined Patent Application Publication No. 10-2010-0084313A. For example, when setting input bit data as 000 010 011 and an initial state starting from 1, the modulated bit is converted into a form of

$$\begin{matrix}00 & 01 & 11 \\ 00 & 01 & 11\end{matrix} .$$

Here, a state becomes a branch path to which a system refers in order to convert the input bit. Since the input bit data is 000, the initial state is modulated from a state of 1 to

$$\begin{matrix}00 \\ 00\end{matrix} ,$$

and a state of

$$00$$

$$00$$

is 1, when next input bit data is 010, the next input bit is modulated to

$$\begin{matrix}01 \\ 01\end{matrix} ,$$

and since a state of

$$\begin{matrix}01 \\ 01\end{matrix}$$

is 2, when the next bit data is 011, the next bit data is modulated to

$$\begin{matrix}11 \\ 11\end{matrix} .$$

Since the conventional modulation code reduces the ISI interference, BER performance is increased. However, it is possible to perform modulation and demodulation only on bit data. Since it is developed in a device of recording and playing data in units of bits, there is a problem in that a method of modulating and demodulating data in units of symbols is not possible.

### SUMMARY OF THE DISCLOSURE

The present disclosure is directed to a data encoding method of multilevel symbol data capable of reducing a two-dimensional inter-symbol interference and the error rate.

Further, the present disclosure is directed to a recording medium in which a computer program for performing a data encoding method of multilevel symbol data is recorded.

Moreover, the present disclosure is directed to a device for performing a data encoding method of multilevel symbol data.

According to one aspect of the present disclosure, there is provided a data encoding method of multilevel symbol data for encoding 3n (here, n is a natural number) symbol data which are input in a multilevel as a modulation page having 4n pixels, the method including: mapping 2n symbol data among the 3n symbol data which are input in the multilevel to symbol data of pixels which are not adjacent to each other in the modulation page one-to-one according to a first mapping rule; converting n symbol data among the 3n symbol data which are input in the multilevel into 2n modulation codes having a modulated level according to a second mapping rule; mapping the 2n modulation codes to symbol data of remaining pixels in the modulation page; and outputting the modulation page in which the 4n pixels including each symbol data which is mapped are arranged in a 2N×2M (here, N and M are natural numbers) arrangement form.

In an embodiment, the modulated level may be configured in a level excluding the highest level and the lowest level in the multilevel.

In an embodiment, the first mapping rule may map in a diagonal direction or a straight line direction to pixels of the 2N×2M arrangement form.

In an embodiment, the first mapping rule may map the symbol data having the multilevel to pixels located in locations (2N, 2M−1) and (2N, 2M) at a modulation page having 2N×2M pixels.

In an embodiment, the second mapping rule may use a mapping table. In an embodiment, the second mapping rule may map the symbol data having the modulated level to pixels located in locations (2N, 2M−1) and (2N, 2M) at the modulation page having 2N×2M pixels.

According to another aspect of the present disclosure, there is provided a computer readable recording medium in which a computer program for executing the data encoding method of the multilevel symbol data according to the present disclosure is recorded.

According to still another aspect of the present disclosure, there is provided a data encoding device of multilevel symbol data for encoding 3n (here, n is a natural number) symbol data which are input in a multilevel as a modulation page in which 4n pixels are arranged in a 2N×2M (here, N and M are natural numbers) arrangement form, wherein the device maps 2n symbol data among the 3n symbol data which are input as a multilevel to symbol data of pixels which are not adjacent to each other in the modulation page one-to-one according to a first mapping rule, converts n symbol data among the 3n symbol data which are input in the multilevel into 2n modulation codes having a modulated level according to a second mapping rule, and maps the 2n modulation codes to symbol data of remaining pixels in the modulation page.

In an embodiment, the modulated level may be configured in a level excluding the highest level and the lowest level in the multilevel.

In an embodiment, the first mapping rule may map in a diagonal direction or a straight line direction to pixels of the 2N×2M arrangement form.

In an embodiment, the second mapping rule may use a mapping table.

In an embodiment, a code conversion rate of the modulation code may be 0.75.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings, in which:

FIG. 1 is a diagram illustrating a page and a modulation code for describing a data encoding method of multilevel symbol data according to an embodiment of the present disclosure;

FIG. 2 is a diagram illustrating a ¾ conversion schema and a modulated code word structure when using symbol data having four levels according to one embodiment of the present disclosure;

FIG. 3 is a diagram illustrating a mapping table representing a mapping rule of FIG. 2;

FIG. 4 is a diagram illustrating a 12/16 conversion schema when using symbol data having four levels according to another embodiment of the present disclosure;

FIG. 5 is a diagram illustrating a modulated code word structure of FIG. 4;

FIG. 6 is a diagram illustrating a mapping table representing a mapping rule of FIG. 5;

FIGS. 7 and 8 are diagrams illustrating modulated code word structures according to still another embodiments of the present disclosure; and

FIG. 9 is a diagram illustrating a graph for showing bit error rate (BER) performance of a proposed modulation code according a signal to noise ratio (SNR) when converting according to a data encoding method of multilevel symbol data according to an embodiment of the present disclosure.

### DETAILED DESCRIPTION OF EXEMPLARY EMBODIMENTS

Exemplary embodiments of the present disclosure are specific embodiments, and will be described in detail below with reference to the accompanying drawings. Exemplary embodiments of the present disclosure will be described below in sufficient detail to enable those of ordinary skill in the art to embody and practice the present disclosure. It should be understood that exemplary embodiments of the present disclosure are different from each other but are not mutually exclusive. For example, specific shape, structure, and characteristics described herein will be implemented as various embodiments without departing from the spirit and scope of the present disclosure. Further, it should be understood that the position and the arrangement of each of elements included in each embodiment are changed without departing from the spirit and scope of the present disclosure. Accordingly, the detailed description which will be described below should not be construed as limited, and when being properly described, the scope of the present disclosure is defined only by the appended claims together with every scope which is equivalent to the scope claimed in the claims. In the drawings, like reference numerals represent functions which are the same or similar in various aspects.

Hereinafter, exemplary embodiments of the present disclosure will be described in more detail.

The present disclosure may propose a data encoding method of recording data in a recording device by minimizing the effects of peripheral noise when communicating and storing information, as well as reducing the final bit error rate (BER) when playing the data.

In an isolated pixel in which the lowest level (or the highest level) symbol is surrounded by the highest level (or the lowest level) symbols in a two-dimensional data structure which is processed in units of pages, the greatest inter-symbol interference (ISI) may be generated.

For example, the ISI may be often generated due to the isolated symbol (0 between four threes or 3 between four zeros) present in each block like

$$\begin{matrix}3 & 0 \\ 303 & 030 \\ 3 & 0\end{matrix} .$$

Accordingly, in order to reduce the ISI, the highest level symbol, 3, should not be adjacent to 0, which is the lowest level symbol.

Accordingly, a data encoding method of multilevel symbol data according to the present disclosure may use a modulation code in which the highest level symbol is not adjacent to the lowest level symbol in order to reduce the ISI when using the multilevel symbol. For example, when using symbol data having four levels 0, 1, 2 and 3, the modulation code may be proposed so as not to generate a situation in which the symbol having a level 0 is adjacent to the symbol having a level 3.

The data encoding method according to the present disclosure may be performed in a data encoding device, and the data encoding device may perform data encoding by installing software (an application) for performing the data encoding of the multilevel symbol data.

The data encoding device may be a separate terminal or a module which is a portion of another terminal. The other terminal may be a data storage device or a communication device configuring one page in an array of a multilevel symbol, and for example, may be holographic data storage (HDS) device, or a flash memory.

When storing data in the data storage device, a method of modulating input data for recording data may be used while minimizing effects of peripheral noise and playing the recorded data easily. The modulation code may need to prevent the ISI which is the interference between pixels in the page from being generated. Particularly, by using the modulation code, it is possible to prevent ISI from occurring, and accordingly, the value of a code rate or the BER may be determined.

Accordingly, in order to solve the problem described above, a symbol data modulation code having a 2×2 arrangement form in which the highest level symbol is not adjacent to the lowest level symbol in the modulation page may be outputted in order to reduce the ISI such that the symbol interference and the BER are reduced.

As an embodiment of the data encoding method according to the present disclosure, when the size of a page is an even number and the symbol data has four levels, three symbol data may be outputted as four symbol data modulation codes having the 2×2 arrangement form.

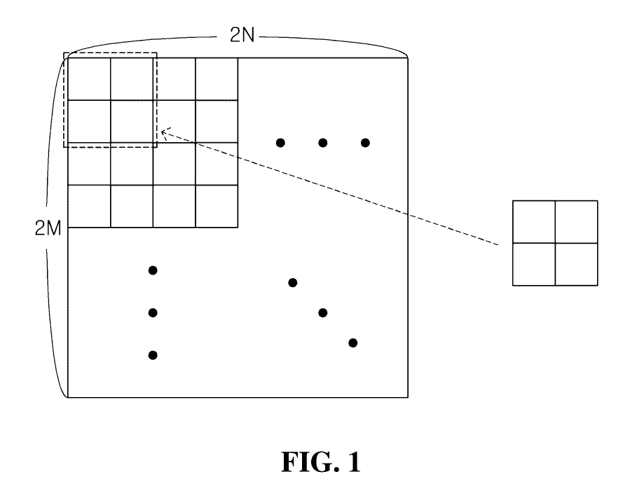

FIG. 1 is a diagram illustrating a page and a modulation code for describing a data encoding method of multilevel symbol data according to an embodiment of the present disclosure.

Referring to FIG. 1, one modulation page is illustrated and has pixels of 2N×2M size, and the page is configured by modulation codes having a 2×2 arrangement form. In other words, in an embodiment of the present disclosure, since four modulation codes have the 2×2 arrangement form and configure a modulation page, the size of the modulation page may be an even number.

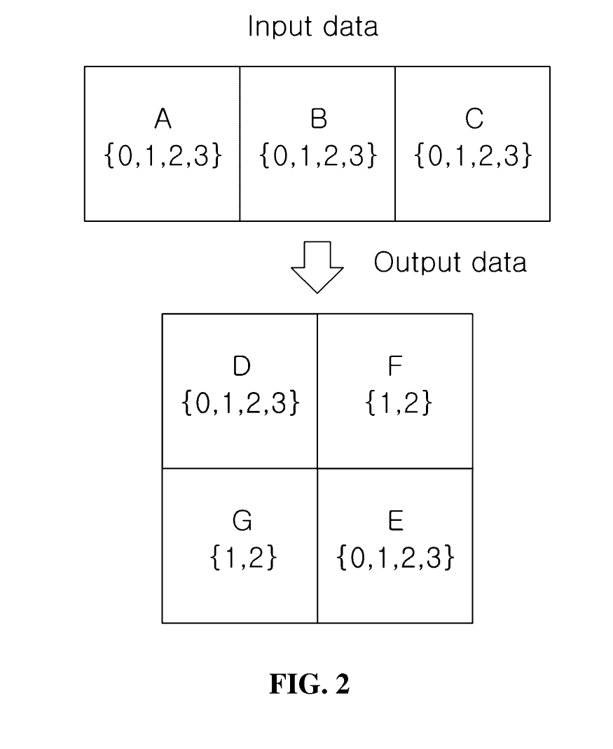

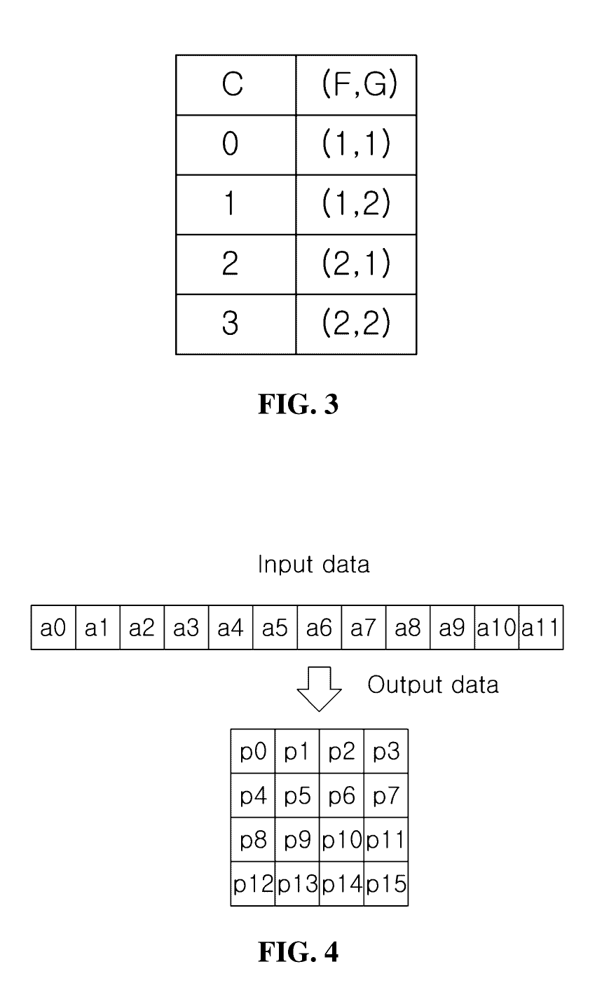

FIG. 2 is a diagram illustrating a ¾ conversion schema and a modulated code word structure when using symbol data having four levels according to one embodiment of the present disclosure. FIG. 3 is a diagram illustrating a mapping table representing a mapping rule of FIG. 2.

Referring to FIG. 2, three symbol data inputs A, B and C may be configured in four levels of 0, 1, 2 and 3. The data encoding device may convert the three symbol data inputs A, B and C into four symbol data modulation codes. At this time, the code conversion rate of the modulation code is 0.75.

The four symbol data modulation codes may be outputted by configuring one modulation page having the 2×2 arrangement form.

The first two symbol data A and B of the three symbol data inputs A, B and C may be mapped one-to-one to pixels which are not adjacent to each other in the modulation page. That is, the two symbol data A and B may use the modulation code that has a symbol data with four levels. However, in this case, the two symbol data A and B may be mapped to the pixels which are not adjacent to each other in up, down, left and right directions in the modulation page.

In one embodiment of the present disclosure, symbol data inputs A and B may be mapped one-to-one to symbol data D and E, and have symbol levels 0, 1, 2, and 3. However, in another embodiment of the present disclosure, the symbol data inputs A and B may be mapped one-to-one to symbol data E and D, respectively.

The symbol data C which is the remaining input data may be converted into two modulation codes having two modulated levels according to the mapping rule. The modulated levels are configured in levels excluding the lowest level and the highest level in the multilevel. That is, the modulated levels are configured as only level 1 and 2, excluding 0 and 3 which are the lowest and highest levels respectively.

When modulating the symbol data C, the mapping rule may use a mapping table shown in FIG. 3. For example, when the symbol value of a pixel C is 2, it may be “10” when converted into a binary number. After this, 2 may be obtained by adding 1 to “1”, which is the first digit of “10” and 2 may be mapped to pixel F, and in the same manner, 1 may be obtained by adding 1 to “0” which is the second digit of “10” and 1 may be mapped to pixel G.

Two modulation codes having the modulated levels may be mapped to the remaining pixels excluding pixels to which the symbol data having four levels are mapped in the modulation page. That is, the two modulation codes may be mapped to the symbols F and G shown in FIG. 2, and the mapped symbol data may have symbols of levels 1 and 2. Accordingly, the output data F and G may not include 0 which is the lowest level symbol and 3 which is the highest level symbol.

At this time, the two modulation codes having the modulated levels may be mapped to symbols F and G, but may be mapped regardless of the order.

Meanwhile, when symbol data inputs A and B are mapped to symbol data F and G, the modulation code of the symbol data C may be mapped to the remaining pixels, D and E.

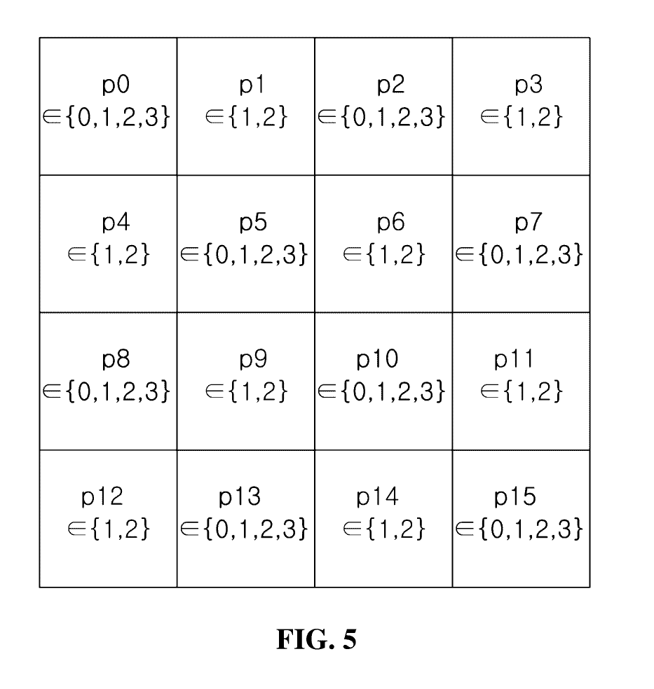

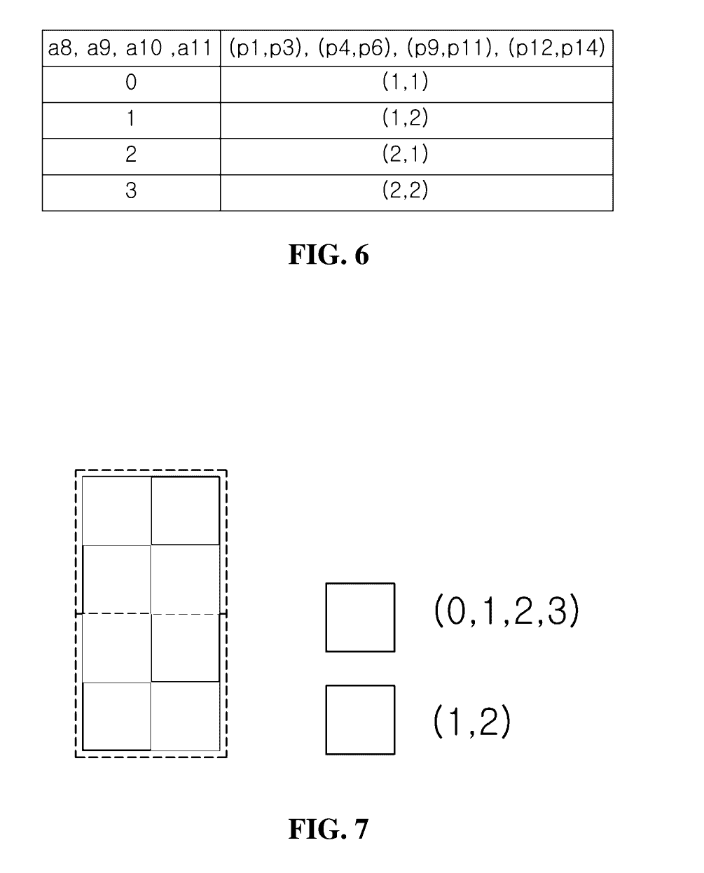

FIG. 4 is a diagram illustrating an example in which the inputting of the 12-symbol data outputs a 16 symbol data in a 4×4 arrangement form. FIG. 5 is a diagram illustrating a structure of the proposed 12/16 modulation codes. FIG. 6 is a diagram illustrating a mapping table representing the mapping rule of FIG. 5.

Referring to FIG. 4, among 12 symbol data a0, a1, a2, a3, a4, a5, a6, a7, a8, a9, a10, and all, which are inputted as a multilevel, 8 symbol data a0, a1, a2, a3, a4, a5, a6, and a7 may be mapped one-to-one to symbol data of pixels which are not adjacent to each other in the modulation page.

For example, symbol data a0, a1, a2, a3, a4, a5, a6, and a7 may be sequentially mapped one-to-one to pixels p0, p5, p10, p15, p2, p7, p8, and p13 which are not adjacent to each other in the modulation page. In this case, the symbol data may be mapped to the pixels which are not adjacent to each other in the modulation page and be mapped in a diagonal direction, a horizontal direction, a vertical direction, etc. regardless of the order, and the order may be changed. For another example, the symbol data a0, a1, a2, a3, a4, a5, a6, and a7 may be sequentially mapped one-to-one to the pixels p0, p2, p5, p7, p8, p10, p13, and p15 in the modulation page.

Accordingly, the symbol data having four levels may be mapped to the pixels p0, p5, p10, p15, p2, p7, p8, and p13 in the modulation page.

Meanwhile, among 12 symbol data a0, al, a2, a3, a4, a5, a6, a7, a8, a9, a10, and all which are inputted as a multilevel, 4 symbol data a8, a9, a10, and all may be converted into 8 modulation codes having a modulated level according to the mapping rule, and may be mapped to symbol data of remaining pixels in the modulation page.

That is, 8 modulation codes having the modulated levels may be mapped to p1, p3, p4, p6, p9, p11, p12, and p14 which are the remaining pixels in the modulation page, and for example, the symbols corresponding to pixels p1 and p3 may be allocated to symbol data a8, the symbols corresponding to pixels p4 and p6 may be allocated to symbol data a9, the symbols corresponding to pixels p9 and p11 may be allocated to symbol data a10, and the symbols corresponding to the pixels p12 and p14 may be allocated to symbol data all.

The modulated level may be configured in levels excluding the highest level and the lowest level in the multilevel, and the modulation code may be configured as only the symbol data having levels 1 and 2 excluding levels 0 and 3.

Accordingly, the symbol data having levels 0, 1, 2 and 3 may be allocated to only the pixels located in p0, p5, p10, p15, p2, p7, p8, and p13 in a code word of the modulation page, and only the symbol data having levels 1 and 2 may be allocated to the remaining pixels in order to reduce the ISI.

In this case, since the case having the levels 0 and 3 in adjacent symbol data disappears, the modulation code according to the present disclosure may reduce the two-dimensional (2D) ISI. As an embodiment, the code conversion rate of the modulation code may be 0.75, and 1.5 bit per a pixel may be recorded.

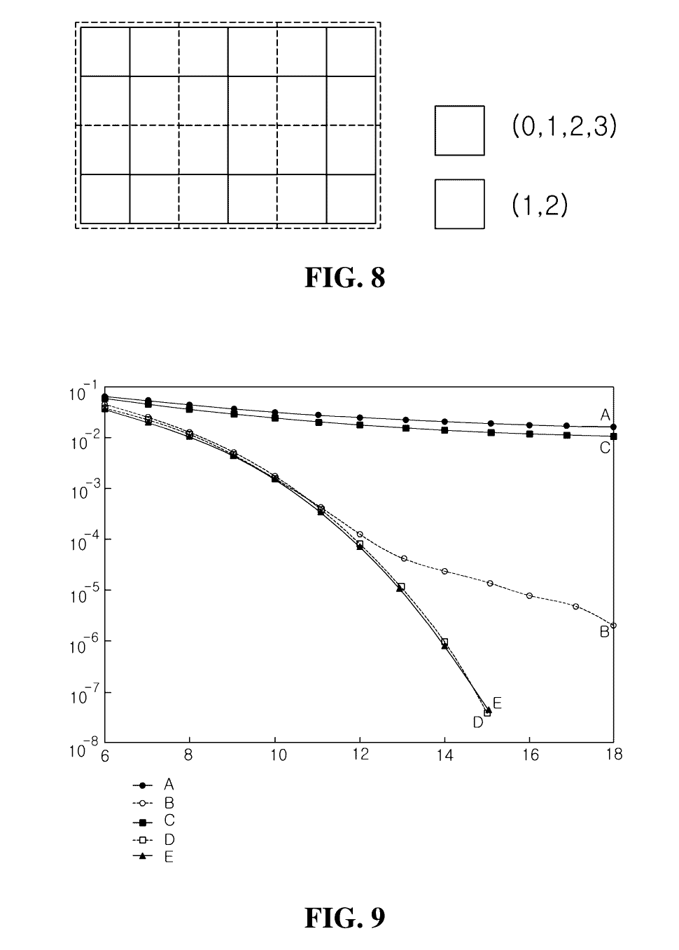

Hereinbefore, the ¾ code conversion and the 12/16 code conversion were described, but the present disclosure is not limited thereto and may be changed in various manners. In another embodiment, 6/8 conversion according to an embodiment of the present disclosure is illustrated in FIG. 7, and 18/24 conversion is illustrated in FIG. 8.

Referring to FIG. 7, the modulation page which is the output may be configured to have modulation codes of a 2×4 arrangement form. Only the pixels which are not adjacent to each other may have symbol data of the levels 0, 1, 2 and 3, and the remainder pixels may only be allocated to have the symbol data of levels 1 and 2. Thus, there may not be a case having the symbol data of the levels 0 and 3 in the pixels which are adjacent to each other.

Referring to FIG. 8, the modulation page may be configured by modulation codes in a 6×4 arrangement form. Similarly, only the pixels which are not adjacent to each other may have the symbol data of the levels 0, 1, 2 and 3, and the remaining pixels may be allocated to the symbol data of the levels 1 and 2. Thus, there may not be a case having the symbol data of the levels 0 and 3 in the pixels which are adjacent to each other.

On generalizing the data encoding method according to the present disclosure, 2n (here, n is a natural number) symbol data among 3n symbol data which are the inputs in the multilevel may be mapped one-to-one to the symbol data of pixels which are not adjacent to each other in the modulation page according to a first mapping rule, and n symbol data out of the 3n symbol data which are the inputs in the multilevel may be converted into 2n modulation codes having modulated levels according to the second mapping rule and the 2n modulation codes may be mapped to the symbol of the remaining pixels in the modulation page. The modulated level may be configured in levels excluding the highest level and the lowest level in the multilevel, and the 4n pixels including the mapped symbol data may output a modulation page arranged in a 2N×2M (here, N and M are a natural number) pixels.

For example, the first mapping rule may map the symbol data having the multilevel to the pixels which are arranged in locations (2N−1, 2M−1) and (2N, 2M) of the 2N×2M pixels, and the second mapping rule may map the symbol data having the modulated levels to the pixels which are arranged in locations (2N−1, 2M) and (2N, 2M−1) of the 2N×2M pixels.

Accordingly, a case in which the symbol data having the lowest level and the symbol data having the highest level are adjacent in the modulation codes which are adjacent to each other may not occur.

FIG. 9 is a diagram illustrating a graph for showing bit error rate (BER) performance of a proposed modulation code according a signal to noise ratio (SNR) when converting according to a data encoding method of multilevel symbol data according to an embodiment of the present disclosure.

A test is performed in a HDS device channel. A size of a page is 1024×1024 pixels, and a noise environment use an additional white Gaussian noise (AWGN). The test is performed under a condition in which blur is 1.85, and dislocations of an X axis and a Y axis is 10%, respectively.

Referring to FIG. 9, a random data channel-out A, a random Viterbi detector B, a channel-out of 12/16 data modulation according to the present disclosure C, and a measurement value of a BER according to a 12/16 data modulation in the present disclosure D according to a SNR in a Viterbi detector are shown.

It may be confirmed that the SNR does not have a great difference before a 12 dB, but the BER is remarkably decreased when modulating data according to the present disclosure after the 12 dB. Further, since a data modulation operation is a one-to-one mapping method, a data demodulation operation may be performed in a reverse order of the data modulation operation, at this time, the BER according to the SNR is represented as E in FIG. 9.

Accordingly, when the present disclosure uses the data storage device configuring one page as an array of the multilevel symbol or the multilevel modulation method proposing in a communication method, it may be confirmed that the ISI is reduced and performance is excellent compared with data in which the SNR is random from 12 dB.

As such, the data encoding method of the multilevel symbol data may be recorded in a computer readable recording medium by being implemented as an application or implemented in a form of program instructions capable of being executed through various computer components. The computer readable recording medium may include program instructions, data files, data structures, etc. by themselves or in combination.

The program instructions, which are recorded in the computer readable recording medium, may be specially designed or configured for the present disclosure or may be known to and be used for one of ordinary skill in the art.

Examples of the computer readable recording medium may include a hard disk, a magnetic medium such as a floppy disk and a hard disk, an optical recording medium such as a compact disk (CD)-read only memory (ROM) and a digital video disk (DVD), a magneto-optical medium such as a floptical disk, and a hardware device which is specially configured to store and perform program instructions such as a ROM, a random access memory (RAM), and a flash memory, etc.

Examples of the program instructions may include high-level language codes which are executable by a computer using an interpreter, etc. as well as machine codes which are made in a computer. The hardware device may be configured to operate as at least one software module in order to perform the operation according to the present disclosure, and vice versa.

According to the data encoding method of the multilevel symbol data, the data may be recorded in the recording device by minimizing effects of the peripheral noise when communicating and storing information, and the final BER may be reduced when playing the data. Particularly, when the size of the page is an even number, the modulation codes according to the present disclosure may be the output as the symbol data modulation codes of the 2×2 arrangement form, and in this case, since the highest level (or the lowest level) symbol and the lowest level (or the highest level) symbol are not adjacent to each other in the two-dimensional data structure processed in units of the pages, the ISI can be reduced.

When using the multilevel modulation method proposed in the present disclosure, since the ISI is reduced and performance is excellent compared with the data in which the SNR is random, it may be diversely applied in the data storage device configuring one page in the array of the multilevel symbol or the communication method.

It will be apparent to those skilled in the art that various modifications can be made to the above-described exemplary embodiments of the present disclosure without departing from the spirit or scope of the disclosure. Thus, it is intended that the present disclosure covers all such modifications provided they come within the scope of the appended claims and their equivalents.

What is claimed is:

1. A data encoding method for 3n number of symbol data, n being a natural number, the method comprising:
mapping, according to a first mapping rule, 2n number of symbol data out of the 3n number of symbol data into a first group, wherein the first group has 2n number of symbol data;
converting, according to a second mapping rule, n number of symbol data out of the 3n number of symbol data into a second group, wherein the second group has 2n number of symbol data, wherein each of a plurality of modulation units includes the first group and the second group;
arranging the first group and the second group in each of the plurality of modulation units, each of the symbol data of the first group being not adjacent to one another, and each of the symbol data of the second group located between the adjacent symbol data of the first group, wherein each of the plurality of the modulation units has 4n number of symbol data; and
outputting a modulation page having 2N×2M pixels, each of N and M being a natural number, wherein the modulation page has the plurality of the modulation units, wherein the 3n number of symbol data have a plurality of levels.

2. The method of claim 1, wherein the second group is comprised of the symbol data excluding both of a highest level and a lowest level of the plurality of levels.

3. The method of claim 2, wherein the first mapping rule is configured to map in a diagonal direction or a straight line direction in the modulation page having 2N×2M pixels.

4. The method of claim 2, wherein the first mapping rule is configured to map the symbol data having the plurality of levels at positions of (2N, 2M−1) and (2N, 2M) in the modulation page having 2N×2M pixels.

5. The method of claim 2, wherein the second mapping rule is configured to use a mapping table.

6. The method of claim 2, wherein the second mapping rule is configured to map the symbol data having the second group at positions of (2N−1, 2M) and (2N, 2M−1) in the modulation page having 2N×2M pixels.

7. A computer readable recording medium in which a computer program for executing the data encoding method, the method comprising:
mapping, according to a first mapping rule, 2n number of symbol data out of the 3n number of symbol data into a first group, wherein the first group has 2n number of symbol data;
converting, according to a second mapping rule, n number of symbol data out of the 3n number of symbol data into a second group, wherein the second group has 2n number of symbol data, wherein each of a plurality of modulation units includes the first group and the second group;
arranging the first group and the second group in each of the plurality of modulation units, each of the symbol data of the first group being not adjacent to one another, and each of the symbol data of the second group located between the adjacent symbol data of the first group, wherein each of the plurality of the modulation units has 4n number of symbol data; and
outputting a modulation page having 2N×2M pixels, each of N and M being a natural number, wherein the modulation page has the plurality of the modulation units, wherein the 3n number of symbol data have a plurality of levels.

8. The computer readable recording medium of claim 7, wherein the second group is comprised of the symbol data excluding both of a highest level and a lowest level of the plurality of levels.

9. The computer readable recording medium of claim 8, wherein the first mapping rule is configured to map in a diagonal direction or a straight line direction in the modulation page having 2N×2M pixels.

10. The computer readable recording medium of claim 8, wherein the first mapping rule is configured to map the symbol data having the plurality of levels at positions of (2N, 2M−1) and (2N, 2M) in the modulation page having 2N×2M pixels.

11. The computer readable recording medium of claim 8, wherein the second mapping rule is configured to use a mapping table.

12. The computer readable recording medium of claim 8, wherein the second mapping rule is configured to map the symbol data having the second group at positions of (2N−1, 2M) and (2N, 2M−1) in the modulation page having 2N×2M pixels.

13. A data encoding device for encoding 3n number of symbol data, n being a natural number, the data encoding device comprising:
a mapping part configured to map, according to a first mapping rule, 2n number of symbol data out of the 3n number of symbol data into a first group, wherein the first group has 2n number of symbol data;
a converting part configured to convert, according to a second mapping rule, n number of symbol data out of the 3n number of symbol data into a second group, wherein the second group has 2n number of symbol data, wherein each of a plurality of modulation units includes the first group and the second group;
an arranging part configured to arrange the first group and the second group in each of the plurality of modulation units, each of the symbol data of the first group being not adjacent to one another, and each of the symbol data of the second group located between the adjacent symbol data of the first group, wherein each of the plurality of the modulation units has 4n number of symbol data; and
an outputting part configured to output a modulation page having 2N×2M pixels, each of N and M being a natural number, wherein the modulation page has the plurality of the modulation units, wherein the 3n number of symbol data have a plurality of levels.

14. The data encoding device of claim 13, wherein the second group is comprised of the symbol data excluding both of a highest level and a lowest level of the plurality of levels.

15. The data encoding device of claim 13, wherein the first mapping rule is configured to map in a diagonal direction or a straight line direction in the modulation page having 2N×2M pixels.

16. The data encoding device of claim 13, wherein the first mapping rule is configured to map the symbol data having the plurality of levels at positions of (2N, 2M−1) and (2N, 2M) in the modulation page having 2N×2M pixels.

17. The data encoding device of claim 13, wherein the second mapping rule is configured to use a mapping table.

18. The data encoding device of claim 13, wherein the second mapping rule is configured to map the symbol data having the second group at positions of (2N−1, 2M) and (2N, 2M−1) in the modulation page having 2N×2M pixels.

19. The data encoding device of claim 13, wherein a code conversion rate of the modulation page is 0.75.
